(19) United States
(12) Patent Application Publication
(10) Pub. No.: US 2021/0047466 A1
(43) Pub. Date: Feb. 18, 2021

(54) BIO-BASED POLYARYLENE ETHER RESIN CONTAINING FURAN RING STRUCTURE AND PREPARATION METHOD THEREFOR

(71) Applicant: DALIAN UNIVERSITY OF TECHNOLOGY, Dalian, Liaoning (CN)

(72) Inventors: Jinyan Wang, Dalian (CN); Xigao Jian, Dalian (CN); Cheng Liu, Dalian (CN); Chengde Liu, Dalian (CN); Shouhai Zhang, Dalian (CN); Zhihuan Weng, Dalian (CN); Fangyuan Hu, Dalian (CN)

(73) Assignee: DALIAN UNIVERSITY OF TECHNOLOGY, Dalian, Liaoning (CN)

(21) Appl. No.: 16/965,572

(22) PCT Filed: Feb. 5, 2018
(86) PCT No.: PCT/CN2018/075319

§ 371 Date: Jul. 28, 2020

(51) Int. Cl. C08G 65/40

(52) U.S. Cl. CPC C08G 65/405

(57) ABSTRACT

The present invention relates to the technical field of polymer science, and disclosed thereby is a bio-based polyarylene ether resin containing a furan ring structure and a preparation method thereof. A bio-based monomer containing a furan ring structure furan-2,5-bis(4-fluorophenyl)methanone (BFBF), which is inventively prepared by using a bio-based derivative furan dicarboxylic acid (FDAC), undergoes a nucleophilic substitution reaction with one or more from a dihydric phenol monomer and a dihalobenzophenone monomer to prepare a bio-based homopolymerized or copolymerized polyaryletherketone resin containing a furan ring structure. The introduction of a bio-base into the field of special engineering plastics diversifies the types of polyaryletherketone resins, while also effectively responding to an oil crisis.

### FIELD OF INVENTION

The present invention belongs to the technical field of polymer science, and relates to a kind of novel polyarylene ether resin and a preparation method thereof, and especially relates to a kind of bio-based polyarylene ether resin containing a furan ring structure and a preparation method thereof.

### BACKGROUND OF THE INVENTION

Polyaryletherketone resin is a kind of novel high-temperature resistance and high-performance engineering plastics. It has the advantages of high heat-resistant grade, excellent mechanical properties, electrical properties, and radiation resistance, chemical resistance, fatigue resistance, impact resistance, creep resistance, wear resistance, flame retardancy, etc. It is widely used in aviation, electronic information, energy and many other high-technology fields. However, the traditional Polyaryletherketone resin is developed on the basis of non-renewable petroleum resources. With the increase of world crude oil consumption and the decrease of oil reserves, the shortage of oil resources is bound to become a shackle for the further development of high-performance engineering plastic Polyaryletherketone resin. Therefore, the research and development of bio-based Polyaryletherketone resin is of great contemporary significance and will become an inevitable trend in the future.

Furan dicarboxylic acid (FDCA) is a bio-based diacid [Lewkowski J. Synthesis, Chemistry and Applications of 5-Hydroxymethyl-furfural and Its Derivatives Cheminform. 2001, 34(2): 37.], which is similar to terephthalic acid (PTA) in structure, and is prepared from the catalytic oxidation of biomass derivative 5-hydroxymethylfurfural (HMF) [Willem P. Dijkman, Daphne E. Groothuis, Marco W. Fraaije. AngewChemInt Ed. 2014, 53(25): 6515-6518]. It is recognized by the US Department of Energy as one of the 12 priority compounds used to establish the future “green” chemical industry. With the growing maturity of the technology for the preparation of bio-based furan dicarboxylic acid, people have tried to use furan dicarboxylic acid instead of terephthalic acid to do many studies, such as polyester containing a furan ring structure (PEF, PPF, PBF) [Knoop R J I, Vogelzang W, Haveren J. Journal of Polymer Science Part A: Polymer Chemistry. 2013, 51(19):4191-4199], epoxy resin [Deng J, Liu X, Li C, Jiang Y, Zhu J. RSC Adv. 2015, 5(21):15930-15939], and polyimide, etc. The above research results show that the introduction of furan ring structure does not reduce the properties of the material, and has significant improvements in some aspects.

This research group is devoted to the research of petroleum-based Polyaryletherketone resin, and has developed a series of Polyaryletherketone resins with excellent performances, which are widely used in aerospace, electronic and electricity, and petroleum exploitation and other industries. In view of this, the present invention starts from furan dicarboxylic acid to prepare bio-based dihalobenzophenone monomers containing a furan ring structure, and inventively utilizes a bio-based dihalobenzophenone monomer containing a furan ring structure furan-2,5-bis(4-fluorophenyl)methanone (BFBF) to develop a kind of bio-based homopolymerized (or copolymerized) polyaryletherketone resin containing a furan ring structure, which aims to use bio-based monomers instead of petroleum-based monomers to prepare polyaryletherketone resin to cope with the oil crisis and environmental problems. There are no public reports so far.

### SUMMARY

The present invention relates to a bio-based polyaryletherketone resin containing a furan ring structure and a preparation method thereof. A bio-based monomer containing a furan ring structure furan-2,5-bis(4-fluorophenyl)methanone (BFBF) undergoes a nucleophilic polycondensation reaction with one or more of dihydric phenol monomers and dihalobenzophenones to prepare a bio-based homopolymerized (or copolymerized) polyaryletherketone resin containing a furan ring structure.

The technical solution of the present invention:

A bio-based polyarylene ether resin containing a furan ring structure, having the following chemical structure:

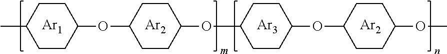

wherein m≥1, n≥0;

the structure of

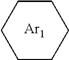

is:

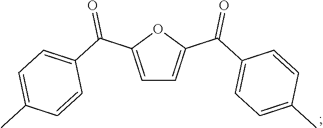

the structure of

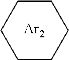

is: one or a combination of two or more of

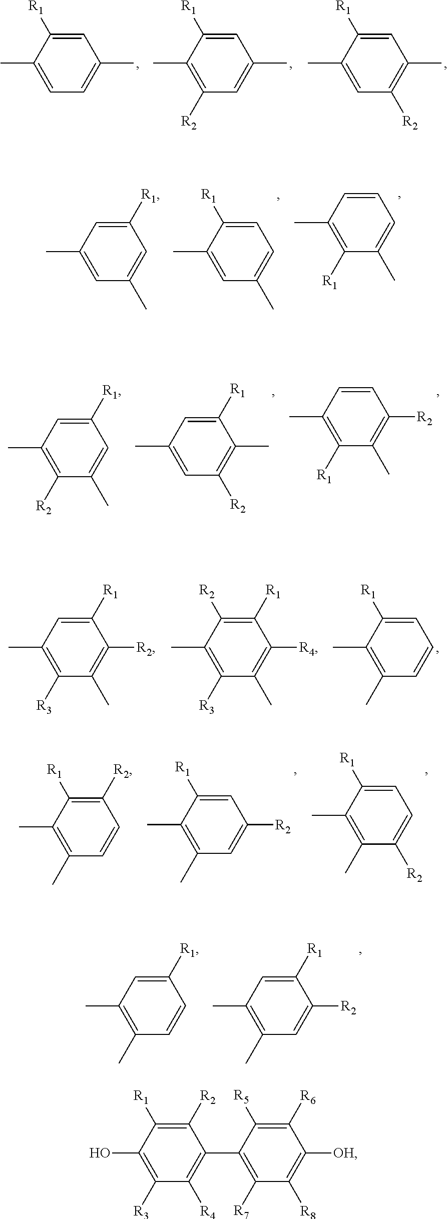

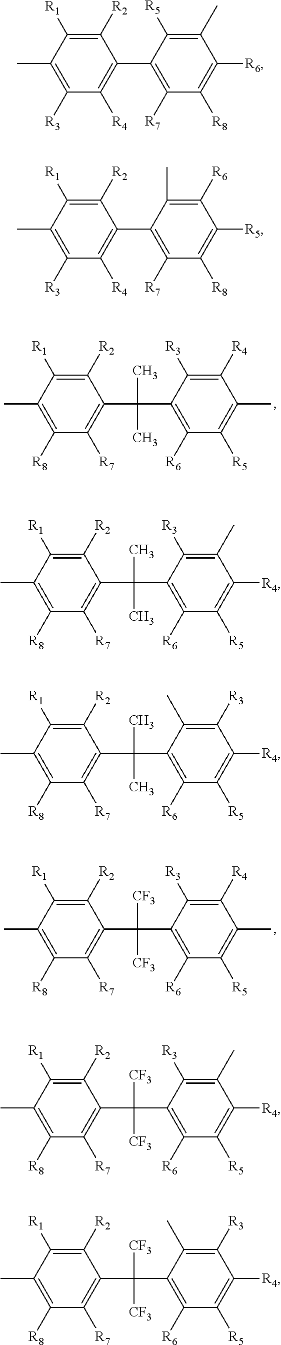

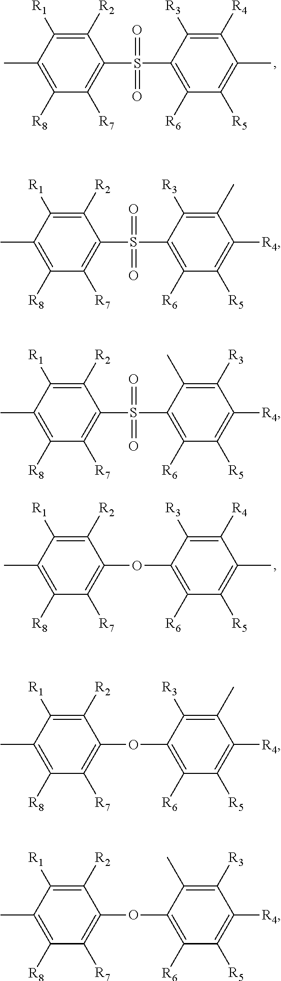

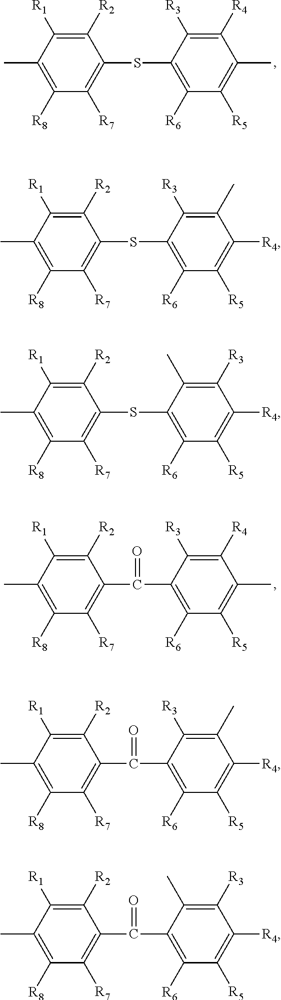

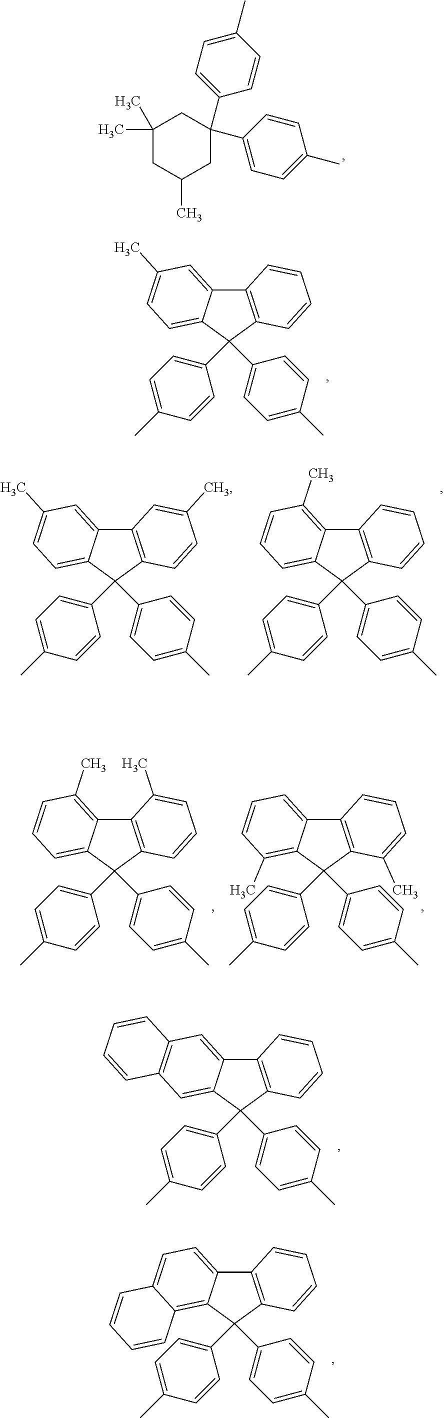

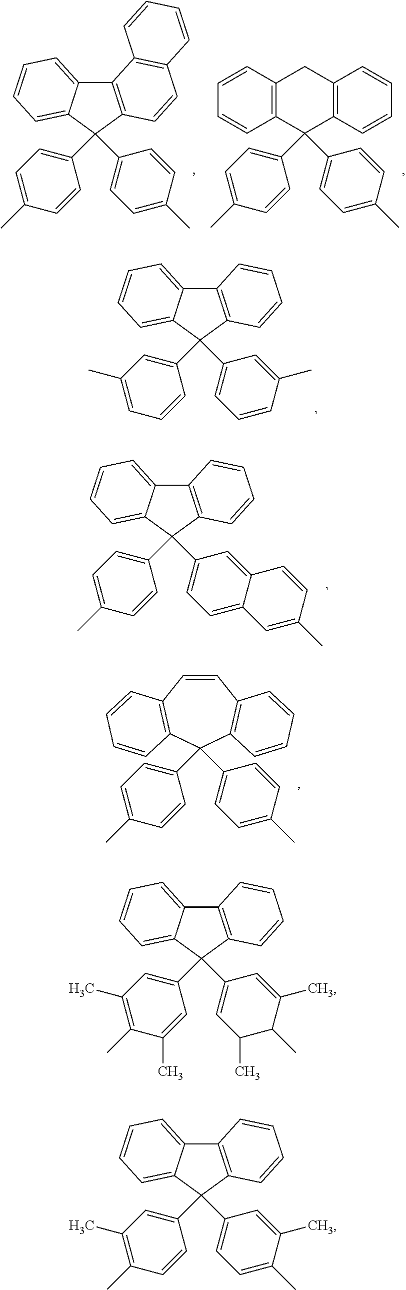

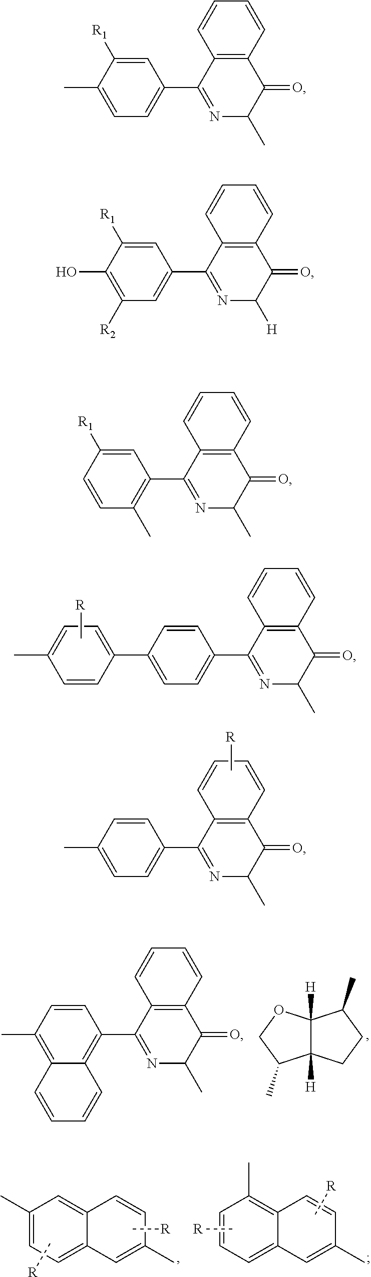

wherein the structures of R, R₁, R₂, R₃, R₄, R₅, R₆, R₇, R₈ are: one or a mixture of two or more of H, F, Cl, Br, I, CN, NH₂, Cᵣ₊₁H₂ᵣ₊₂, CrH₂ᵣ₊₁, CrH₂ᵣ₊₁COOH, OCrH₂ᵣ₊₁, CF₃,

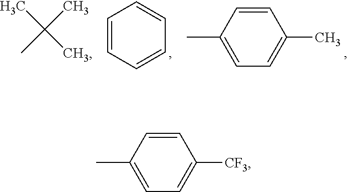

r≥1; R, R₁, R₂, R₃, R₄, R₅, R₆, R₇, and R₈ are the same or different;

the structure of

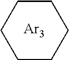

is: one or a mixture of two or more of

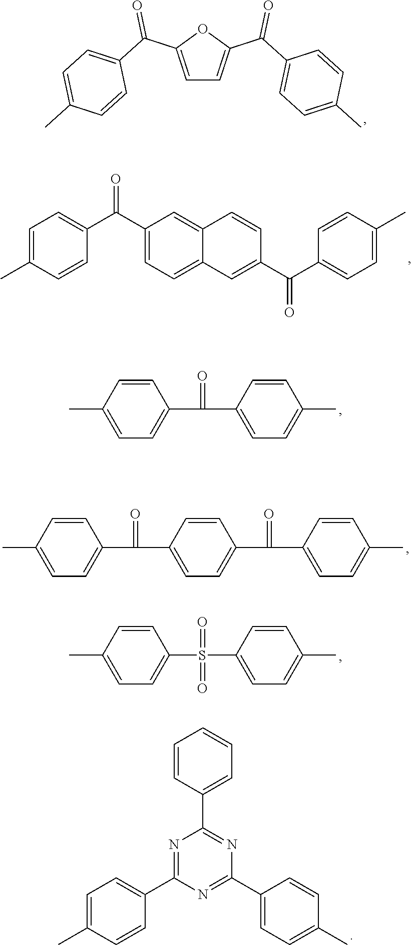

A preparation method of a bio-based polyarylene ether resin containing a furan ring structure, its polymerization reaction formula and steps are as follows:

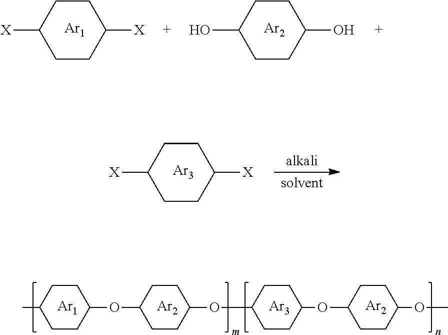

wherein m≥1, n≥0, X is F, Cl, Br, I;

the structure of

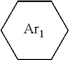

is:

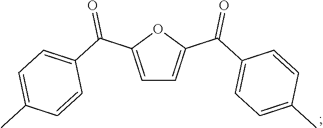

the structure of

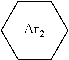

is: one or a combination of two or more of

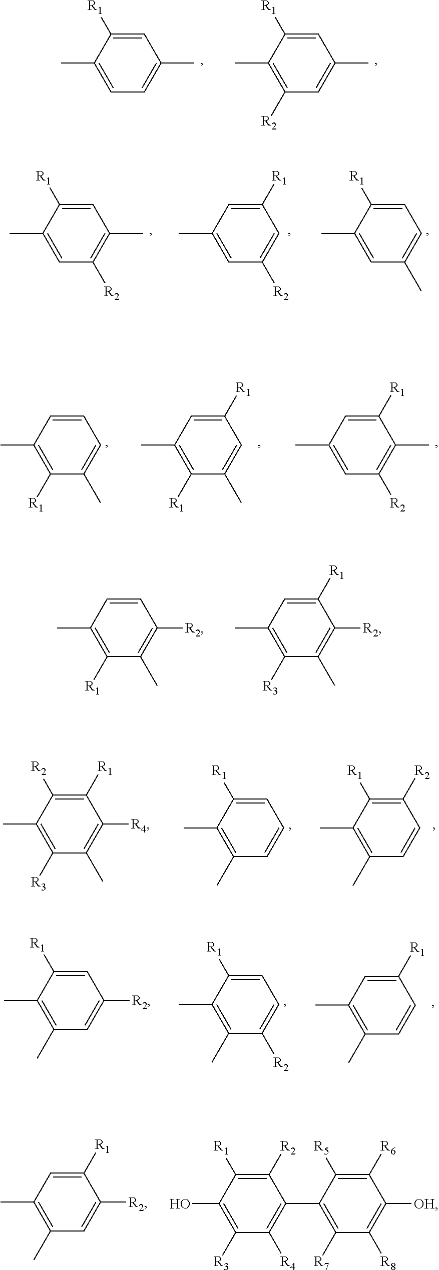

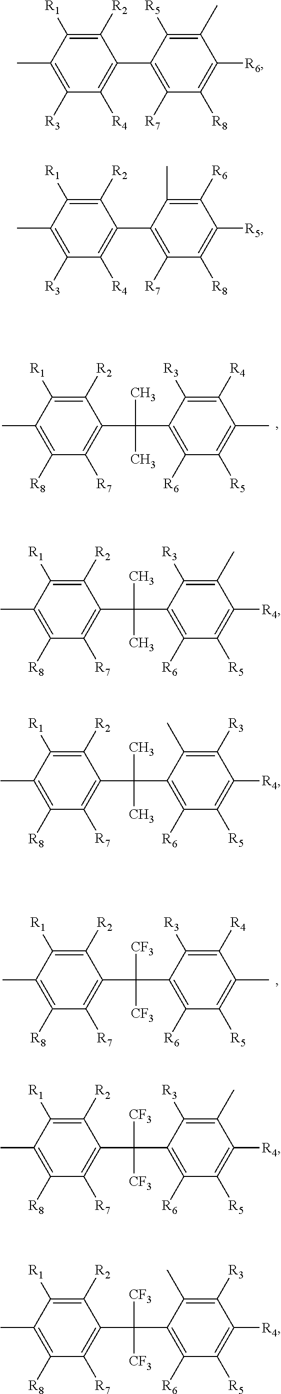

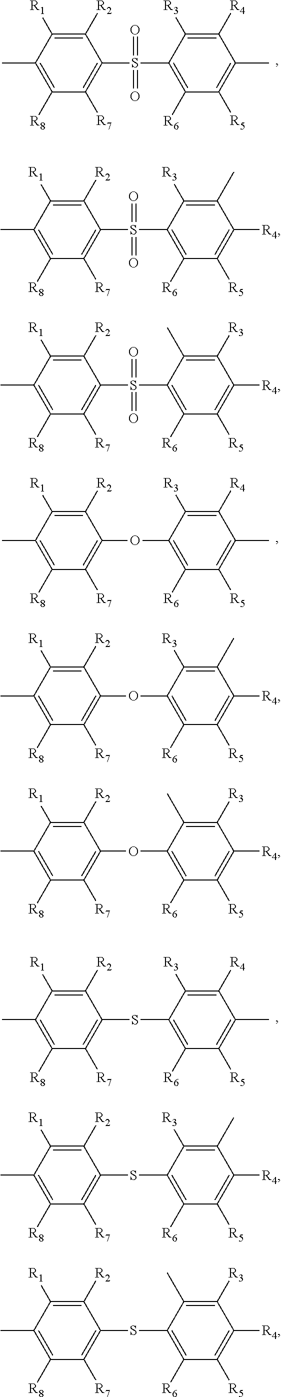

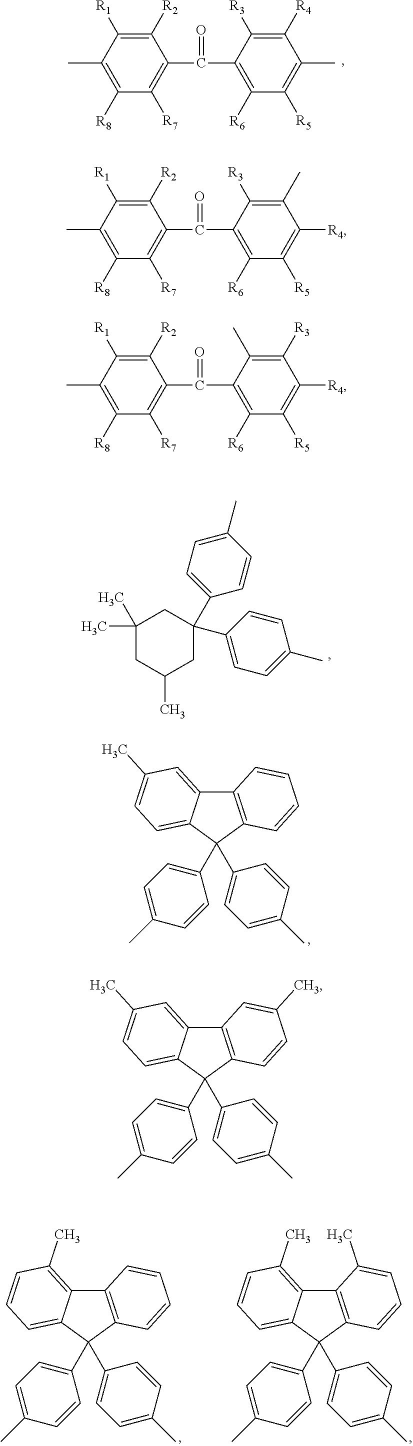

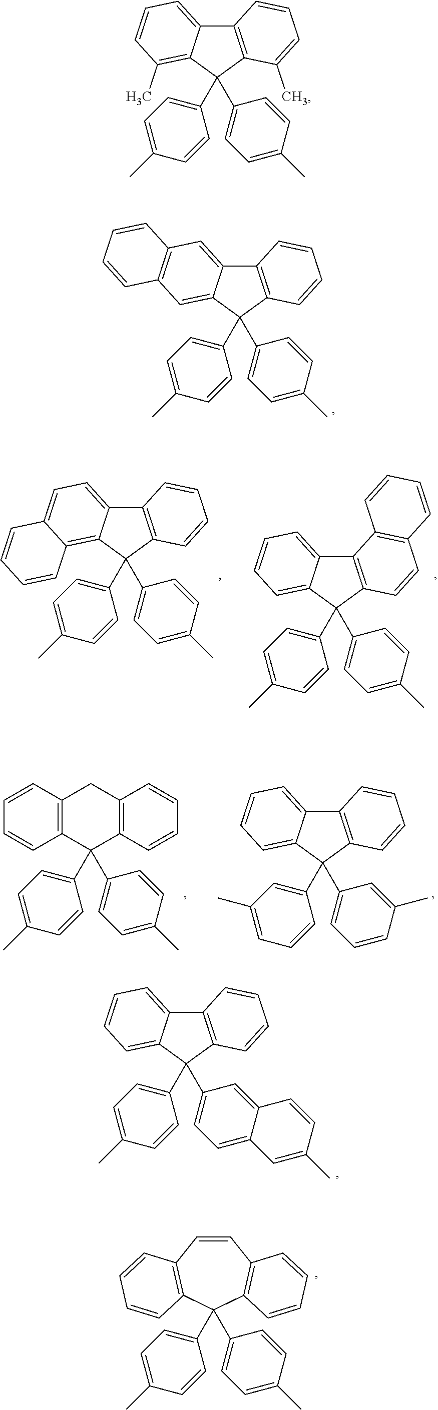

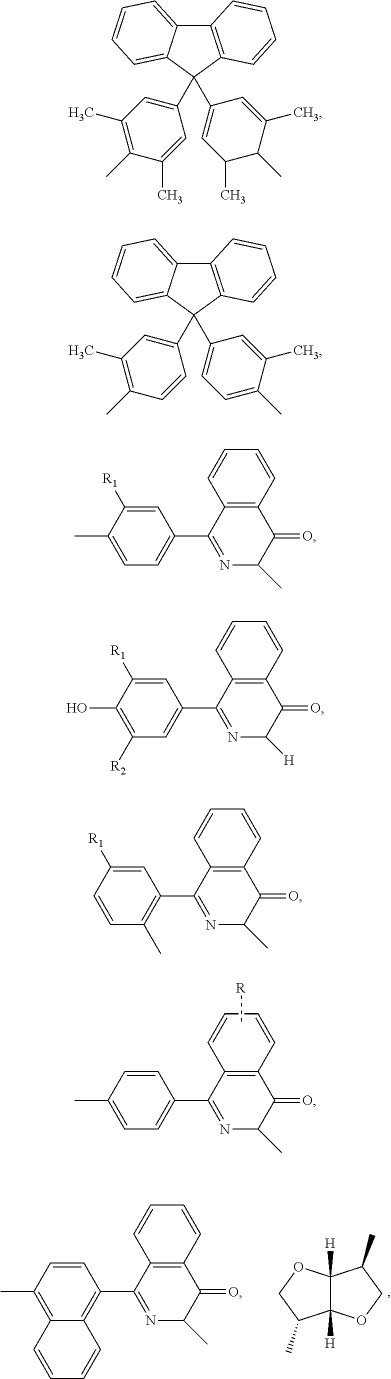

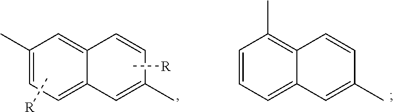

wherein the structures of R, R₁, R₂, R₃, R₄, R₅, R₆, R₇, R₈ are one or a mixture of two or more of H, F, Cl, Br, I, CN, NH₂, Cᵣ₊₁H₂ᵣ₊₂, CrH₂ᵣ₊₁, CrH₂ᵣ₊₁COOH, OCrH₂ᵣ₊₁, CF₃,

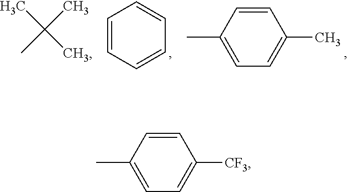

r≥1; R, R₁, R₂, R₃, R₄, R₅, R₆, R₇, and R₈ are the same or different;

the structure of

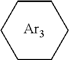

is: one or a mixture of two or more of

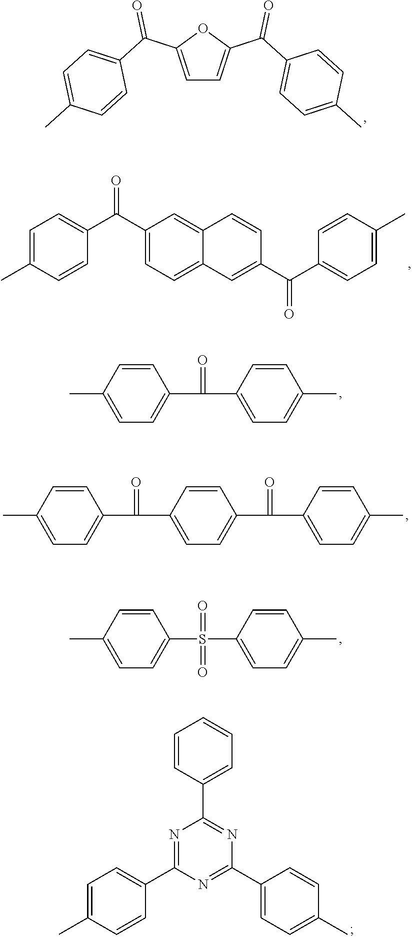

the specific synthesis steps are that:

under the protection of inert gas, a dihalogen monomer containing a furan ring structure of

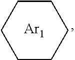

a dihydric phenol monomer containing a structure of

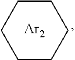

a dihalogen monomer containing a structure of

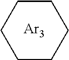

and an alkali were mixed, and then a strong polar non-protonic solvent and an azeotropic solvent were added, the reaction system was dewatered at 110-150° C. for 0.5-3 h; later the azeotropic solvent is removed, and then the reaction was heated to 160-200° C. for 5-10 h, and thereafter a viscous solution was slowly poured into a settling agent to obtain a fibrous material, the fibrous material was boiled in boiling water for 10-24 h after filtering and dried at 100-150° C. for 10-24 h and dried under vacuum at 90-150° C. to constant weight to obtain a crude product of a bio-based homopolymerized or copolymerized polyaryletherketone resin containing a furan ring structure; the polyaryletherketone resin crude product was dissolved in a good solvent, wherein a ratio of the mass of the crude product and the volume of the good solvent was 1:5-1:35; and then a filtration is performed and a filtrate is settled into the settling agent, and then filtering, blow drying, vacuum drying in sequence were performed to obtain the refined bio-based polyarylene ether resin containing a furan ring structure;

wherein the molar ratio of phenolic hydroxyl to halogen was 1:0.9-1:1.1, the molar ratio of alkali to phenolic hydroxyl was 1:1.2-1:2.2; the volume ratio of azeotropic solvent and mixed solvent was 1:1-1:3.

The dihalogen monomer containing a furan ring structure of

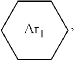

the reaction formulas and the preparation method thereof are as follows:

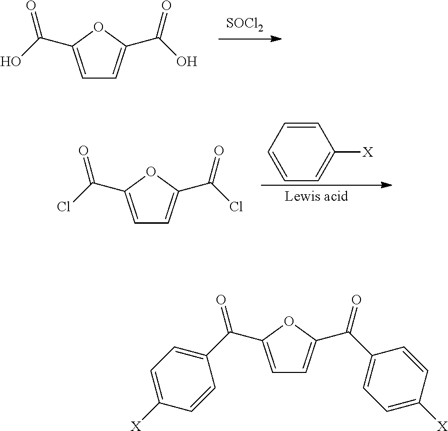

wherein the structure of X is: one of F, Cl, Br, I.

Taking

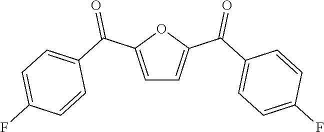 [SMILES: O=C(c1ccc(F)cc1)c1ccc(C(=O)c2ccc(F)cc2)o1]

as an example, the specific synthesis steps are:

in the first step, a furan dicarbonyl dichloride intermediate was synthesized: bio-based furan dicarboxylic acid and thionyl chloride in a mass ratio of 0.2:1-1:1 were added into the reaction vessel equipped with magnetic stirring; at the same time, a small amount of strong polar non-protonic solvent DMF (1% of the volume of thionyl chloride) was added, the reaction temperature was 60-100° C., and the reaction time was 2-6 hours; after the reaction is completed, the temperature of the system was reduced to room temperature and excess thionyl chloride was removed, and a white furan dicarbonyl dichloride FDCC crystal was obtained by vacuum sublimation;

in the second step, under the protection of inert gas, the bio-based intermediate containing a furan ring structure FDCC and fluorobenzene were used as raw materials, with Lewis acid used as a catalyst, to react in a low boiling point organic solvent to prepare the target monomers; wherein the molar ratio of FDCC to fluorobenzene is 1:2-1:5, the volume ratio of low boiling point organic solvent to FDCC is 1:3-1:5, the molar ratio of Lewis acid catalyst to FDCC was 1:2-1:5; the reaction temperature was 25-100° C., the reaction time was 10˜24 h; after the reaction was completed, the product was settled in the settling agent, and a bio-based dihalobenzophenone monomer containing a furan ring structure BFBF is obtained by pumping filtration, purification and drying.

Wherein the inert gas is one of nitrogen, argon, and helium.

The Lewis acid is one or a mixture of two or more of boron trichloride, boron tribromide, boron trifluoride and aluminum trichloride.

The low boiling point organic solvent is one or a mixture of two or more of chloroform, dichloromethane, dichloroethane, and acetonitrile.

The alkali is one or a mixture of two or more of potassium carbonate, cesium carbonate, sodium carbonate, sodium hydroxide, and potassium hydroxide.

The strong polar non-protonic solvent is one or a mixture of two or more of N, N-dimethylformamide, N, N-dimethylacetamide, dimethyl sulfoxide, N-methylpyrrolidone, and sulfolane.

The azeotropic solvent is one or a mixture of two or more of toluene, xylene and chlorobenzene.

The good solvent is one or a mixture of two or more of N, N-dimethylformamide, N, N-dimethylacetamide, dimethyl sulfoxide, N-methylpyrrolidone, sulfolane, and chloroform.

The settling agent is one or a mixture of two or more of methanol, ethanol, isopropanol, acetone, and water.

The beneficial effects of the present invention are that bio-based dihalobenzophenone monomers containing a furan ring structure were designed and synthesized by using the bio-based monomer furan dicarboxylic acid, and then a series of bio-based homopolymerized (or copolymerized) polyaryletherketone resin containing a furan ring structure with excellent properties were prepared. This kind of resin can not only effectively deal with oil crisis, but also adjust and control to obtain the target resin with high-temperature resistance, dissolution, easy processing, and excellent mechanical properties to meet the actual demand.

### BRIEF DESCRIPTION OF THE DRAWINGS

FIG. 1 is 1H-NMR spectrum of a bio-based polyaryletherketone resin PFBEK containing a furan ring structure;

FIG. 2 is 1H-NMR spectrum of a bio-based polyaryletherketone resin PFBEK containing a furan ring structure;

FIG. 3 is FT IR spectrum of bio-based polyaryletherketone resins containing a furan ring structure PFBEK and PFDEK;

### DETAILED DESCRIPTION OF THE EMBODIMENTS

The preparation method and performances of bio-based polyaryletherketone resin containing a furan ring structure of the present invention are further described in detail by examples below, but it does not indicate the limitation of the present patent.

### Example 1 Preparation of PFBEK

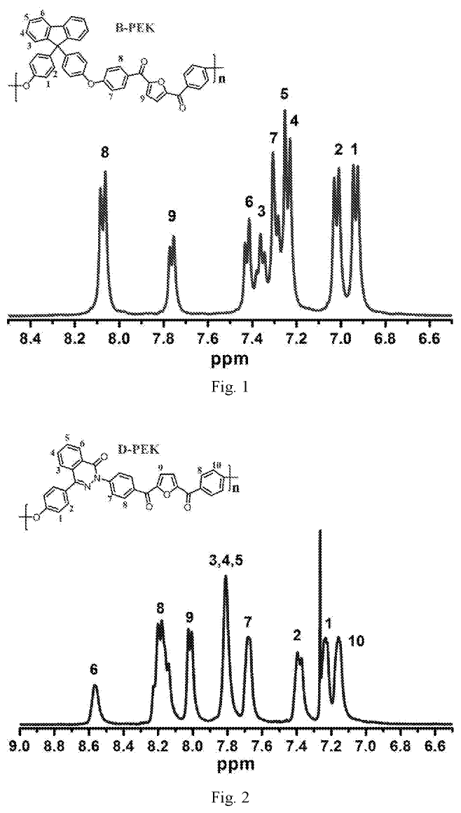

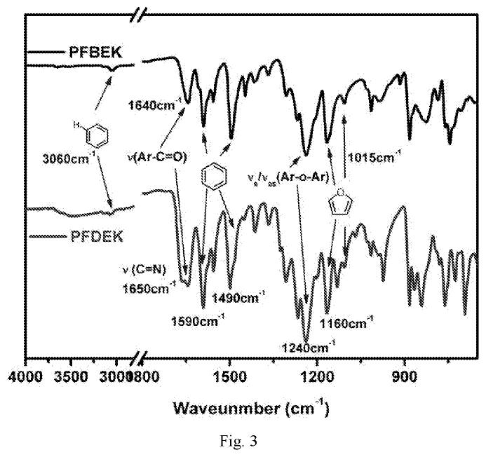

Under the protection of nitrogen atmosphere, in a three-mouth-flask (three-necked flask) equipped with mechanical agitation, the bio-based monomer containing a furan ring structure BFBF (10 mmol, 3.1227 g), 9,9-bis (4-hydroxyphenyl) fluorene BPF (10 mmol, 3.5042 g) and anhydrous potassium carbonate K₂CO₃ (14 mmol, 1.9023 g) were dissolved in a mixed solvent of 4 ml sulfolane, 1 ml N-methyl pyrrolidone and 10 ml toluene, and reacted for 4 h at 125° C.-160° C. The mixed system was evaporated to remove toluene, and then heated to 195° C. to react for 10 h. The viscous solution was poured into hot water to obtain white fibrous polymer. After boiling for 8 h-12 h in the boiling water, it was dried to constant weight to obtain white bio-based polyaryletherketone resin containing a furan ring structure PFBEK crude product. The crude product was dissolved in chloroform in a certain proportion, and then filtered. The filtrate was settled in anhydrous ethanol, and then filtered, blow dried, vacuum dried in sequence to obtain the refined target product PFBEK with the 99.9% of yield. The ¹HNMR and IR characterization of PFBEK are shown in FIG. 1 and FIG. 2, and the characterization of heat resistance is shown in Table 1.

The structural formula is as follows:

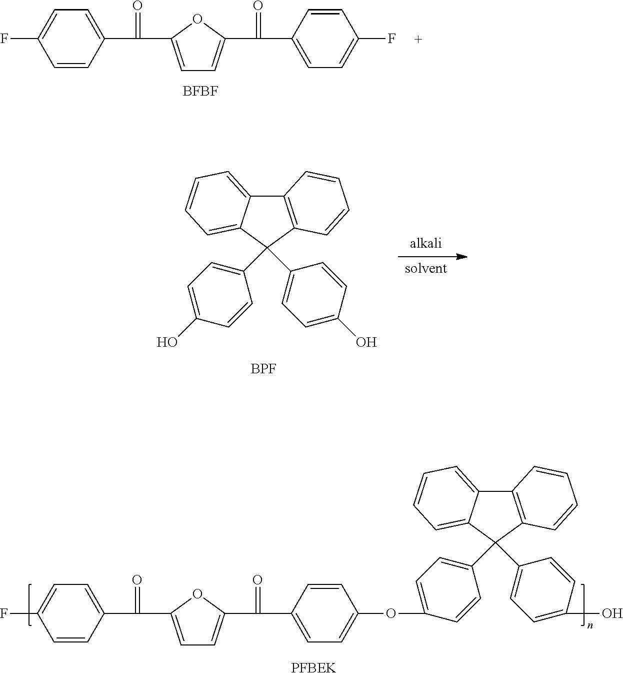

### Example 2 Preparation of Polymer PFDEK

Under the protection of nitrogen atmosphere, in a three-mouth-flask equipped with mechanical agitation, the bio-based monomer containing a furan ring structure BFBF (10 mmol, 3.1227 g), 4-(4-hydroxyphenyl)-phthlazin-1(2H)-one (DHPZ) (10 mmol, 2.3824 g) and anhydrous potassium carbonate K₂CO₃ (14 mmol, 1.9023 g) were dissolved in a mixed solvent of 3 ml sulfolane, 2 ml N, N-dimethylacetamide and 10 ml toluene, and reacted for 4 h at 125° C.-160° C. The mixed system was evaporated to remove toluene, and then heated to 195° C. to react for 10 h. At last, the viscous solution was poured into hot water to obtain a white fibrous polymer. After boiling for 8 h-12 h in the boiling water, it is dried to constant weight to obtain the white bio-based polyaryletherketone resin containing a furan ring structure PFDEK crude product. The crude product was dissolved in chloroform in a certain proportion, and then filtered. The filtrate was settled in anhydrous ethanol, and then filtered, blow dried, vacuum dried in sequence to obtain the refined target product PFDEK with the 99.9% of yield. The ¹HNMR and IR characterization of PFDEK are shown in FIG. 3 and FIG. 2, and thermal performance test data is shown in Table 1.

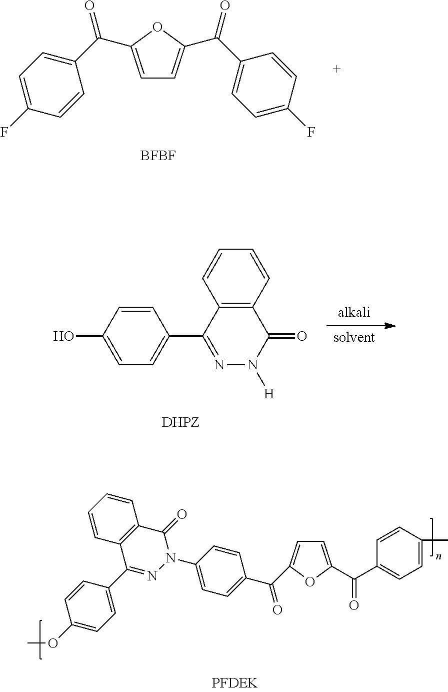

TABLE 1
Thermal performance test results of bio-based
polyaryletherketone resin containing a furan
ring structure PFBEK and PFDEK.

| | | TGA in N₂ | | | TGA in air | | | GPC | | |
|---|---|---|---|---|---|---|---|---|---|---|
| | T_{g}^{a}/ | T_{d5%}^{d}/ | T_{d10%}^{d}/ | C_{y}^{e}/ | T_{d5%}^{d}/ | T_{d10%}^{d}/ | C_{y}^{e}/ | Mn | Mw | |
| Sample | ° C. | ° C. | ° C. | % | ° C. | ° C. | % | (g/mo^{b} | (g/mol)^{b} | PD |
| PFBEK | 225 | 493 | 512 | 61.2 | 464 | 498 | 1.8 | 26385 | 65175 | 2.47 |
| PFDEK | 239 | 480 | 498 | 59.5 | 450 | 481 | 1.7 | 25890 | 63045 | 2.43 |

1. A bio-based polyarylene ether resin containing a furan ring structure, characterized in that the bio-based polyarylene ether resin containing a furan ring structure has the following chemical structure: 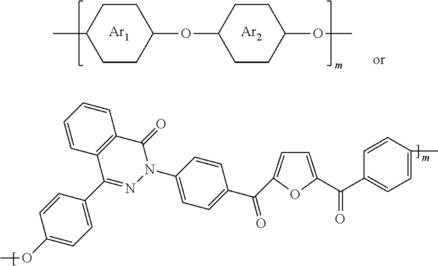
wherein m≥1;
the structure of 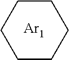
is: 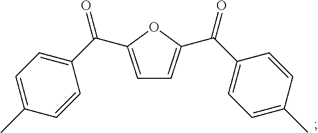
the structure of 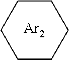
is: one or a combination of two or more of

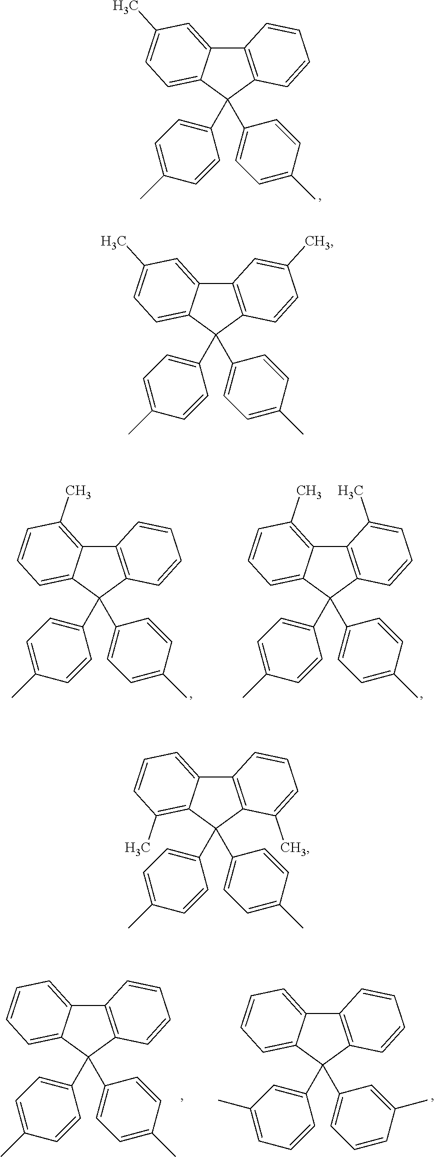

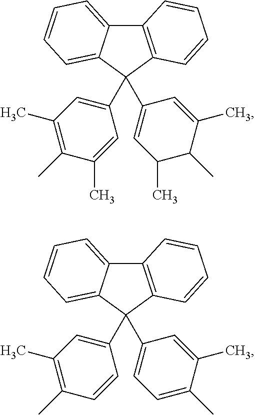

2. A preparation method of a bio-based polyarylene ether resin containing a furan ring structure, characterized in that polymerization reaction formula and steps of the preparation method are as follows: 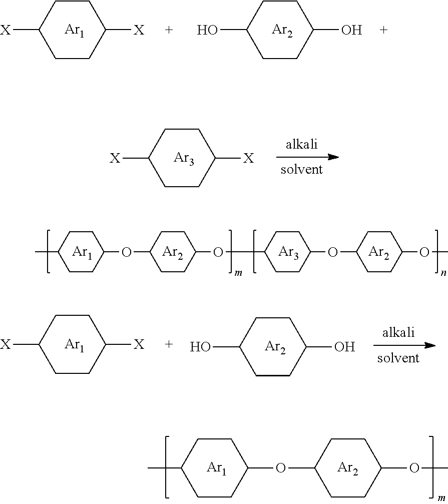
wherein m≥1, X is any one of F, Cl, Br, I;
the structure of 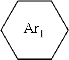
is: 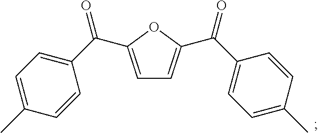
the structure of 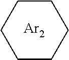
is: one or a combination of two or more of 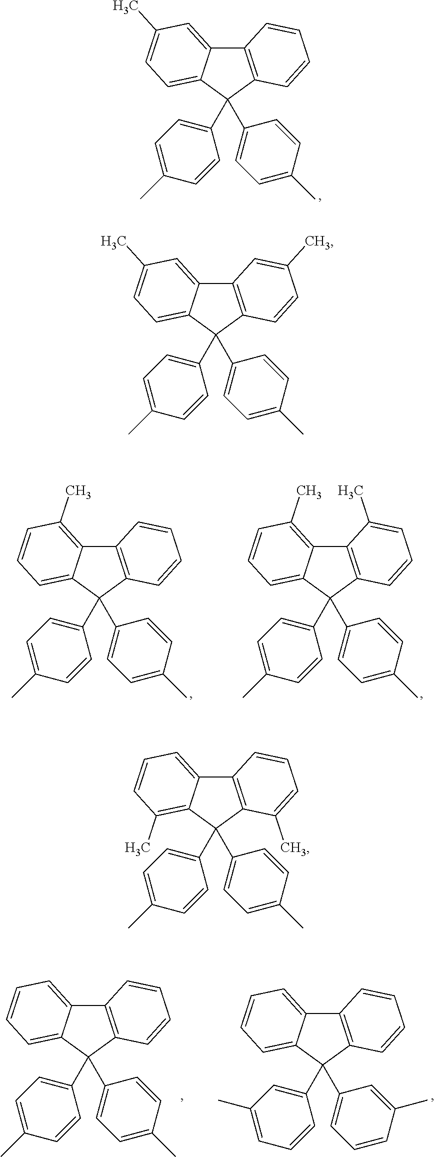 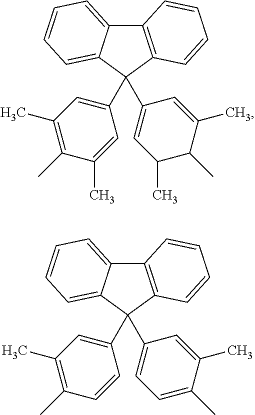
the specific synthesis steps are:
under the protection of inert gas, a dihalogen monomer containing a furan ring structure of 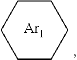
a dihydric phenol monomer containing a structure of 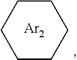
and an alkali were mixed, and then a strong polar non-protonic solvent and an azeotropic solvent were added, the reaction system was dewatered at 110-150° C. for 0.5-3 h; later the azeotropic solvent is removed, and then the reaction was heated to 160-200° C. for 5-10 h, and thereafter a resulting viscous solution was slowly poured into a settling agent to obtain a fibrous material, the fibrous material was boiled in boiling water for 10-24 h after filtering and dried at 100-150° C. for 10-24 h and dried under vacuum at 90-150° C. to constant weight to obtain a crude product of a bio-based copolymerized polyaryletherketone resin containing a furan ring structure; the polyaryletherketone resin crude product was dissolved in a good solvent, wherein a ratio of the mass of the crude product and the volume of the good solvent was 1:5-1:35, and then a filtration is performed and a filtrate is settled into the settling agent, and then filtering, blow drying, vacuum drying in sequence were performed to obtain a refined bio-based polyarylene ether resin containing a furan ring structure;
wherein the molar ratio of phenolic hydroxyl to halogen was 1:0.9-1:1.1, the molar ratio of alkali to phenolic hydroxyl was 1:1.2-1:2.2, the volume ratio of azeotropic solvent and mixed solvent was 1:1-1:3;
or polymerization reaction formula and steps of the preparation method are as follows: 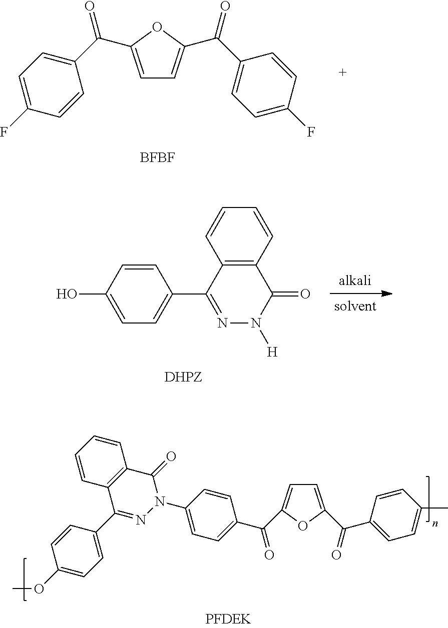
under the protection of nitrogen atmosphere, in a three-mouth-flask equipped with mechanical agitation, 10 mmol the bio-based monomer containing a furan ring structure BFBF, 10 mmol 4-(4-hydroxyphenyl)-phthlazin-1(2H)-one (DHPZ), and 14 mmol anhydrous potassium carbonate K₂CO₃ were dissolved in a mixed solvent of 3 ml sulfolane, 2 ml N, N-dimethylacetamide and 10 ml toluene, and reacted for 4 h at 125° C.-160° C., the mixed system was evaporated to remove toluene, and then heated to 195° C. to react for 10˜11, at last, the viscous solution was poured into hot water to obtain a white fibrous polymer, after boiling for 8 h-12 h in the boiling water, it is dried to constant weight to obtain the white bio-based polyaryletherketone resin containing a furan ring structure PFDEK crude product the crude product was dissolved in chloroform in a certain proportion, and then filtered, the filtrate was settled in anhydrous ethanol, and then filtered, blow dried, vacuum dried in sequence to obtain the refined target product PFDEK.

3. The preparation method according to claim 2, characterized by the dihalogen monomer containing a furan ring structure of 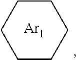
the reaction formulas are as follows: 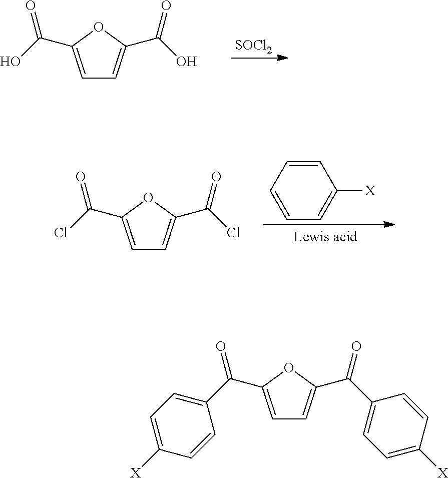
wherein the structure of X is one of F, Cl, Br, I.

4. The preparation method according to claim 3, characterized in that the specific synthesis steps of 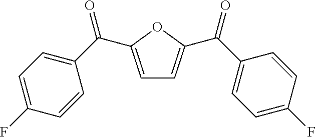 [SMILES: O=C(c1ccc(F)cc1)c1ccc(C(=O)c2ccc(F)cc2)o1]
are:
in the first step, a furan dicarbonyl dichloride intermediate was synthesized: bio-based furan dicarboxylic acid and thionyl chloride in a mass ratio of 0.2:1-1:1 were added into the reaction vessel equipped with magnetic stirring at the same time, a strong polar non-protonic solvent DMF with a volume of 1% of the volume of thionyl chloride was added, the reaction temperature was 60-100° C., and the reaction time was 2-6 h; after the reaction was completed, the temperature of the system was reduced to room temperature and excess thionyl chloride was removed, and a white bio-based intermediate containing a furan ring structure of furan dicarbonyl dichloride FDCC crystal was obtained by vacuum sublimation;
in the second step, under the protection of inert gas, the bio-based intermediate containing a furan ring structure FDCC and fluorobenzene were used as raw materials, with Lewis acid used as a catalyst, to react in a low boiling point organic solvent to prepare the target monomer; wherein the molar ratio of FDCC to fluorobenzene was 1:2-1:5, the volume ratio of low boiling point organic solvent to FDCC was 1:3-1:5, the molar ratio of Lewis acid catalyst to FDCC was 1:2-1:5; the reaction temperature was 25-100° C., the reaction time was 10˜24 h; after the reaction was completed, the product was settled in the settling agent, and a product was obtained by pumping filtration, purification and drying.

5. The preparation method according to claim 4, characterized in that the alkali is one or a mixture of two or more of potassium carbonate, cesium carbonate, sodium carbonate, sodium hydroxide and potassium hydroxide.

6. The preparation method according to claim 5, characterized in that the strong polar non-protonic solvent is one or a mixture of two or more of N,N-dimethylformamide, N,N-dimethylacetamide, dimethyl sulfoxide, N-methylpyrrolidone, and sulfolane.

7. The preparation method according to claim 4, characterized in that the azeotropic solvent is one or a mixture of two or more of toluene, xylene and chlorobenzene.

8. The preparation method according to claim 7, characterized in that the good solvent is one or a mixture of two or more of N,N-dimethylformamide, N,N-dimethylacetamide, dimethyl sulfoxide, N-methylpyrrolidone, sulfolane, and chloroform.

9. The preparation method according to claim 4, characterized in that the settling agent is one or a mixture of two or more of methanol, ethanol, isopropanol, acetone, and water.

10. The preparation method according to claim 9, characterized in that the inert gas is one of nitrogen gas, argon gas and helium gas; the Lewis acid is one or a mixture of two or more of boron trichloride, boron tribromide, boron trifluoride and aluminum trichloride; the low boiling point organic solvent is one or a mixture of two or more of chloroform, dichloromethane, dichloroethane, and acetonitrile.

11. The preparation method according to claim 6, characterized in that the azeotropic solvent is one or a mixture of two or more of toluene, xylene and chlorobenzene.

12. The preparation method according to claim 11, characterized in that the good solvent is one or a mixture of two or more of N,N-dimethylformamide, N,N-dimethylacetamide, dimethyl sulfoxide, N-methylpyrrolidone, sulfolane, and chloroform.

13. The preparation method according to claim 6, characterized in that the settling agent is one or a mixture of two or more of methanol, ethanol, isopropanol, acetone, and water.

14. The preparation method according to claim 8, characterized in that the settling agent is one or a mixture of two or more of methanol, ethanol, isopropanol, acetone, and water.

15. The preparation method according to claim 12, characterized in that the settling agent is one or a mixture of two or more of methanol, ethanol, isopropanol, acetone, and water.

16. The preparation method according to claim 13, characterized in that the inert gas is one of nitrogen gas, argon gas and helium gas; the Lewis acid is one or a mixture of two or more of boron trichloride, boron tribromide, boron trifluoride and aluminum trichloride; the low boiling point organic solvent is one or a mixture of two or more of chloroform, dichloromethane, dichloroethane, and acetonitrile.

17. The preparation method according to claim 14, characterized in that the inert gas is one of nitrogen gas, argon gas and helium gas; the Lewis acid is one or a mixture of two or more of boron trichloride, boron tribromide, boron trifluoride and aluminum trichloride; the low boiling point organic solvent is one or a mixture of two or more of chloroform, dichloromethane, dichloroethane, and acetonitrile.

18. The preparation method according to claim 15, characterized in that the inert gas is one of nitrogen gas, argon gas and helium gas; the Lewis acid is one or a mixture of two or more of boron trichloride, boron tribromide, boron trifluoride and aluminum trichloride; the low boiling point organic solvent is one or a mixture of two or more of chloroform, dichloromethane, dichloroethane, and acetonitrile.
